(19) United States
(12) Patent Application Publication
(10) Pub. No.: US 2009/0315823 A1
(43) Pub. Date: Dec. 24, 2009

(54) Liquid crystal display and method for driving the same

(75) Inventors: Chi-Hsin Chen, Miao-Li (TW); Hai-Jun Xiong, Shenzhen (CN); Chen-Hsun Liao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/456,632

(22) Filed: Jun. 19, 2009

(30) Foreign Application Priority Data
Jun. 19, 2008 (CN) 200810067971.2

(51) Int. Cl. G09G 3/36

(52) U.S. Cl. 345/102

(57) ABSTRACT

A liquid crystal display includes a control unit, an inverter connected to the control unit and a load connected to the inverter. The control unit provides a first control signal and a second control signal to the inverter according to a degree of brightness of an external image signals. The inverter adjusts luminous intensity of the load according to the first control signal and the second control signal. Also provided is a method for driving the liquid crystal display.

### BACKGROUND

1. Technical Field

The present disclosure relates to displays, and more particularly to a liquid crystal display and a method for driving the same.

2. Description of Related Art

Liquid crystal displays have gradually replaced cathode ray tube (CRT) displays in display field due to a slim profile and images of good quality with lower power consumption and radiation.

A commonly used liquid crystal display includes a liquid crystal display panel and a backlight driving circuit. The backlight driving circuit provides light for the liquid crystal display panel which emits no light by itself. Controls are generally disposed on the external surface of the liquid crystal display, allowing luminous intensity provided by the backlight driving circuit and thereby brightness of the image to be adjusted when the liquid crystal display panel displays the image.

Brightness for the liquid crystal display may be set when the surrounding environment is dimly illuminated; however, the backlight driving circuit is incapable of luminous intensity self-adjustment once set.

Accordingly, high luminous intensity of light may not be currently required to display images by the liquid crystal display. Thus, if the liquid crystal display has been previously set at high luminous state, that power is wasted.

Furthermore, since the backlight driving circuit provides light of a specified luminous intensity, when the liquid crystal display displays a dark image or a black image, brightness of the image may be excessive, causing quality of the display to suffer.

What is needed, therefore, is a liquid crystal display and a method for driving the liquid crystal display which may overcome the described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram a first embodiment of a liquid crystal display of the present disclosure.

FIG. 2 is a diagram showing one embodiment of a wave shape of the modulation current of the backlight driving circuit 10 of FIG. 1.

FIG. 3 is a block diagram illustrating a second embodiment of a liquid crystal display of the present disclosure.

FIG. 4 is a schematic diagram showing one embodiment of the regulation unit of FIG. 3.

FIG. 5 is a diagram showing one embodiment of a wave shape of the modulation current of a backlight driving circuit of FIG. 3.

FIG. 6 is a block diagram illustrating a third embodiment of a liquid crystal display of the present disclosure.

FIG. 7 is a schematic diagram showing one embodiment of a regulation unit of FIG. 6.

### DETAILED DESCRIPTION

Reference will now be made to the drawings to describe certain inventive embodiments of the invention in detail.

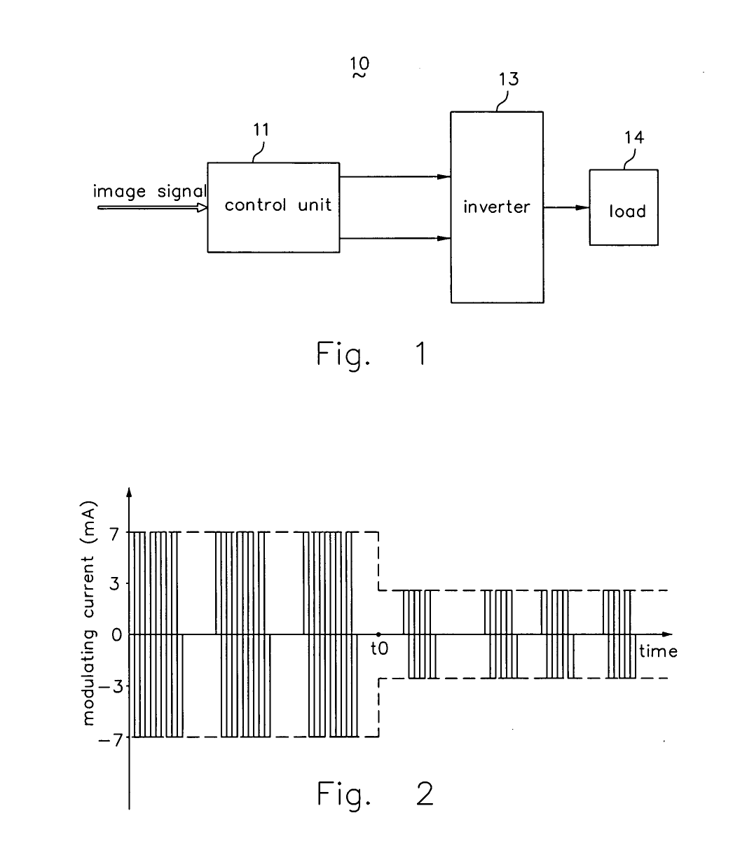

FIG. 1 is a block diagram of a first embodiment of a backlight driving circuit 10 for a liquid crystal display of the present disclosure. The liquid crystal display includes a liquid crystal display panel (not shown) and the backlight driving circuit 10. The backlight driving circuit 10 provides light for the liquid crystal display panel. The liquid crystal display panel displays images according to an external image signal.

The backlight driving circuit 10 includes a control unit 11, an inverter 13 and a load 14. The control unit 11 provides a first control signal and a second control signal to the inverter 13 according to a degree of brightness of the external image signal. The inverter 13 adjusts a working current of the load 14 according to the first control signal and the second control signal respectively. The load 14 provides light having different luminous intensities under various working currents. The first and the second control signals are pulse signals, and each includes a duty ratio. The duty ratio is a ratio of the signal duration within a cycle of the pulse signal to the duration of the whole cycle. The load 14 may comprise one or more lamps, such as cold cathode fluorescent lamps, for example.

The control unit 11 receives the external image signal and determines the received external image signal during a normal operation of the backlight driving circuit 10.

Before the external image signal corresponding to a black image is received by the control unit 11, the first control signal output by the control unit 11 may be set according to a displayed brightness of the image required by a user. The black image, representing a frame, is set according to the requirement. For example, an image is set to be a black image when an average gray level value of the image is less than a specific gray level value, and the image being is set to be a white image when the average gray level value of the image is greater than the specific gray level value. The range of the duty ratio of the first control signal may range from 0% to 100%. For example, the user may adjust the duty ratio of the first control signal by an external on screen display (OSD) unit connected to the control unit 11, and the OSD unit may include controls extended on the external surface of the liquid crystal display, so that the user may easily use the controls. When the liquid crystal display displays images, the duty ratio of the first control signal ranges from 35% to 100%; the lowest brightness set by the controls corresponds to the duty ratio of the first control signal being 35%. Meanwhile, the control unit 11 may output the second control signal having a predetermined first duty ratio, and the first duty ratio of the second control signal may be 100%.

When receiving the image signal corresponding to the black image, the control unit 11 may output the first control signal having a corresponding duty ratio according to calculation result of the received image signal. The calculation result represents an average brightness value of the image corresponding to the received image signal. A predetermined linear or nonlinear relationship may exist between the calculation result and the duty ratio of the first control signal. For example, the calculation result may range from 0 to 100, where “0” represents a darkest image (in this case, the image signal corresponds to the entire black image), and “100” represents a brightest image (in this case, the image signal corresponds to the entire white image). In one embodiment, the range of the duty ratio of the first control signal may range from 20% to 100%. A determining circuit (not shown) pre-configured in the control unit 11 may be used to implement the calculation process of the image signal. For example, relationships between various signal images and corresponding brightness values may be preloaded in the determining circuit. When all or a portion of image signals of a single image are received, the determining circuit may determine the received image signals to obtain the corresponding brightness values of the image. Meanwhile, the control unit 11 may output the second control signal having a second duty ratio, and thereafter the output second control signal will maintain the second duty ratio thereof. The first duty ratio is greater than the second duty ratio. For example, the second duty ratio may be 20%. Thus, the duty ratio of the second control signal is changed from the first duty ratio to the second duty ratio after the control unit 11 receives the image signal corresponding to the black image. Afterwards, the second control signal maintains the second duty ratio during the subsequent operation of the backlight driving circuit 10.

The inverter 13 receives the first control signal and the second control signal and output a modulation current to the load 14, where the first control signal is capable of adjusting a duty ratio of the modulation current, and the second control signal is capable of adjusting an amplitude of the modulation current. The magnitude of the modulation current is in direct proportion to both of the duty ratio of the first control signal and the duty ratio of the second control signal. The reduction of the duty ratio of either of the first control signal and the second control signal alone will result in the reduction of the modulation current. The modulation current is reduced when the duty ratio of the first control signal and the duty ratio of the second control signal are reduced simultaneously. The duty ratio of the working current of the load 14 depends on the duty ratio of the modulation current, and the amplitude of the working current of the load 14 depends on the amplitude of the modulation current. Thus, the working current of the load 14 is reduced when the modulation current is reduced.

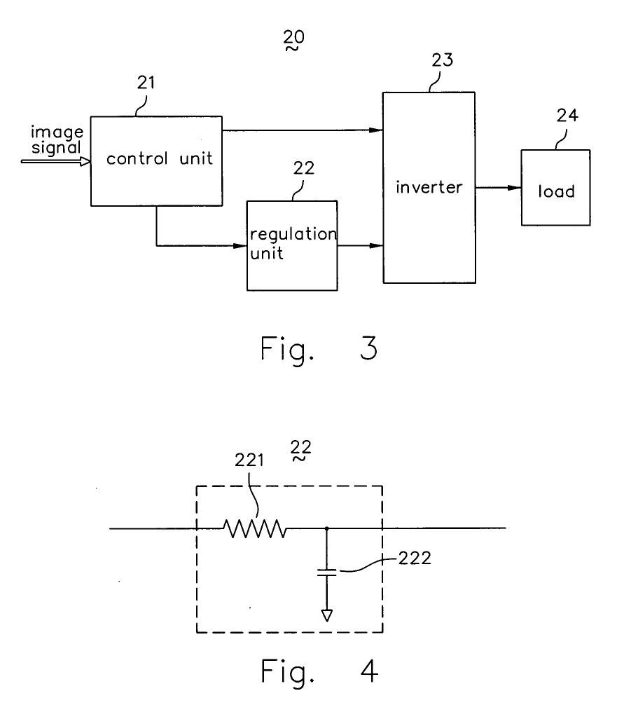

FIG. 2 is a diagram showing one embodiment of a wave shape of the modulation current of the backlight driving circuit 10 of FIG. 1. The control unit 11 receives the image signal corresponding to a black image at time t0. In FIG. 2, the duty ratio of the first control signal is reduced, whereby the duty ratio of the modulation current is reduced after time t0. Meanwhile, the duty ratio of the second control signal is reduced from the first duty ratio to the second duty ratio, and the corresponding modulation voltage is reduced from a first modulation voltage to a second modulation voltage; therefore, the amplitude of the modulation current is reduced.

Thus, the backlight driving circuit 10 adjusts luminous intensity of the load 14 according to the received image signal, so that the liquid crystal display displays the black image with relatively low brightness, thus providing better effect for the image displayed by the liquid crystal display.

FIG. 3 is a block diagram of a second embodiment of a liquid crystal display of the present disclosure. The liquid crystal display includes a liquid crystal display panel (not shown) and a backlight driving circuit 20. The backlight driving circuit 20 provides light for the liquid crystal display panel. The liquid crystal display panel displays images according to the external image signal.

The backlight driving circuit 20 includes a control unit 21, a regulation unit 22, an inverter 23 and a load 24. The control unit 21 provides a first control signal to the inverter 23 according to an external image signal and a second control signal to the regulation unit 22 according to the external image signal. The liquid crystal display panel receives the image signal and displays an image with corresponding brightness. The regulation unit 22 receives the second control signal and provides a modulation voltage to the inverter 23 according to the second control signal. The inverter 23 receives the first control signal and the modulation voltage and provides a modulation current to the load 24 according to the first control signal and the modulation voltage; the modulation current corresponding to the working current of the load 24. The first control signal is capable of adjusting a duty ratio of the modulation current, and the second control signal is capable of adjusting amplitude of the modulation current. The modulation voltage is a direct current voltage. The load 24 provides light for the liquid crystal display panel. The first and the second control signals are pulse signals and each has a duty ratio. The load 24 may be multiple cold cathode fluorescent lamps or the like. The load 24 is disposed on the lateral side of the liquid crystal display panel; alternatively, the load 24 is disposed on the rear face of the liquid crystal display panel.

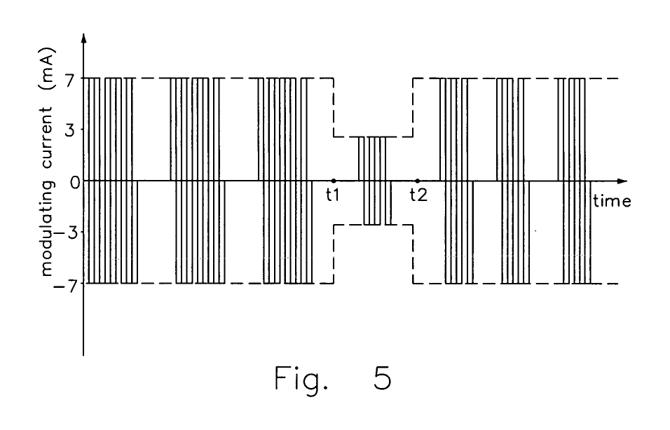

FIG. 4 is a schematic diagram showing one embodiment of the regulation unit 22 of FIG. 3. The regulation unit 22 includes a resistor 221 and a capacitor 222. The resistor 221 is connected between the control unit 21 and the inverter 23. The capacitor 222 is connected between a node and ground, where the node is positioned between the resistor 221 and the inverter 23. The resistor 221 and the capacitor 222 physically constitute a RC circuit. When receiving pulse signals, the RC circuit may integrate the pulse signals into the direct current voltage and output the direct current voltage. The direct current voltage is in direct proportion to the duty ratio of the pulse signals. In other words, the low duty ratio of the pulse signals leads to the low direct current voltage. A resistance of the resistor may be 1 kΩ, and capacitance of the capacitor may be 47 μF.

The regulation unit 22 includes the RC circuit including the resistor 221 and the capacitor 222; therefore, the integrating circuit may transform the second control signal into the modulation voltage.

The control unit 21 receives the external image signal and determines the received image signal during the normal operation of the backlight driving circuit 20.

The control unit 21 may output the first control signal before receiving the image signal corresponding to a black image, wherein the duty ratio of the first control signal is set according to a requirement for brightness of the image as requested. The range of the duty ratio of the first control signal is 0% to 100%. For example, the user may adjust the duty ratio of the first control signal by an OSD unit connected to the control unit 21; the OSD unit may include controls disposed on the external surface of the liquid crystal display for easy access. Meanwhile, the control unit 21 may output the second control signal having a predetermined first duty ratio, which may be 100%.

When receiving the image signal corresponding to a first reference brightness value, the control unit 21 may output the first control signal with a corresponding duty ratio according to calculation result of the received image signal. The calculation result represents an average brightness value of the image corresponding to the received image signal. A predetermined linear or nonlinear relationship may exist between the calculation result and the duty ratio of the first control signal. For example, the calculation result may range from 0 to 100, where “0” represents a darkest image (in this case, the image signal corresponds to the black image), and “100” represents a brightest image (in this case, the image signal corresponds to a white image); the range of the duty ratio of the first control signal is from 20% to 100%. A determining circuit pre-configured in the control unit 21 may implement the calculation process of the image signal. For example, relationships between various signal images and corresponding brightness values may be stored in the determining circuit in advance. When all or a portion of image signals of a single image are received, the determining circuit may determine the received image signals and thereby obtain the corresponding brightness values of the image.

Meanwhile, the control unit 21 may output the second control signal having a predetermined second duty ratio. The first duty ratio is greater than the second duty ratio. For example, the second duty ratio may be 20%. Then, the duty ratio of the second control signal is returned to the first duty ratio when the control unit 21 receives an image signal corresponding to a second reference brightness value.

The image brightness corresponding to the first reference brightness value is less than the image brightness corresponding to the second reference brightness value. For example, the image corresponding to the first reference brightness value may be a black image, and the image corresponding to the second reference brightness value a white image. Moreover, the manufacturer, depending on user requirements, may set the first reference brightness value and the second reference brightness value.

Thus, the duty ratio of the second control signal is changed from the first duty ratio to the second duty ratio after the control unit 21 receives the image signal corresponding to the first reference brightness value; the duty ratio of the second control signal is shifted between the first duty ratio and the second duty ratio according to the image brightness corresponding to the image signal received by the control unit 21.

In view of the above, the control unit 21 may output the second control signal having the first duty ratio before receiving the image signal corresponding to the first reference brightness value, and at this stage, the modulation voltage output by the regulation unit 22 is defined as a first modulation voltage. The control unit 21 may output the second control signal having the second duty ratio after receiving the image signal corresponding to the first reference brightness value; and at this stage, the modulation voltage output by the regulation unit 22 is defined as a second modulation voltage. The first modulation voltage is greater than the second modulation voltage because the first duty ratio is greater than the second duty ratio. For example, when the first and the second duty ratios are 100% and 20% respectively, the first modulation voltage may be about 2.1 V and the second modulation voltage may be about 0.6 V.

The inverter 23 receives the first control signal and the modulation voltage and provides a modulation current to the load 24 according to the first control signal and the modulation voltage. The magnitude of the modulation current is in direct proportion to the duty ratio of the first control signal and also in direct proportion to the magnitude of the modulation voltage. The reduction of the duty ratio of either of the first control signal and the second control signal alone will result in the reduction of the modulation current. The modulation current is reduced when the duty ratio of the first control signal and the modulation voltage are reduced simultaneously. The magnitude of the working current of the load 24 depends on the magnitude of the modulation current. Thus, when the modulation current is reduced, the working current of the load 24 is reduced.

FIG. 5 is a diagram showing one embodiment of a wave shape of the modulation current of the backlight driving circuit 20 of FIG. 3. The control unit 21 receives the image signal corresponding to the black image at time t1. In FIG. 5, the duty ratio of the first control signal is reduced, and whereby the duty ratio of the modulation current is reduced after time t1. Meanwhile, the duty ratio of the second control signal is reduced from the first duty ratio to the second duty ratio, and the modulation voltage corresponding to the second control signal is reduced from the first modulation voltage to the second modulation voltage. Therefore, the amplitude of the modulation current is reduced. Thus, the luminous intensity of the load 24 is relatively low when the liquid crystal display displays the black image, so that the brightness of the image is relatively low when the liquid crystal display displays the black image, thus the liquid crystal display can display better effects for the image. The control unit 21 receives the image signal corresponding to the white image at time t2, while the duty ratio of the first control signal is increased, and the duty ratio of the second control signal changes from the second duty ratio to the first duty ratio, causing the modulation voltage to change from the second modulation voltage to the first modulation voltage. Therefore, the duty ratio of the modulation current and the amplitude of the modulation current increase correspondingly. In this way, the backlight driving circuit 20 may reduce the luminous intensity of the load 24 when the liquid crystal display panel displays the black image, and the backlight driving circuit 20 may increase the luminous intensity of the load 24 when the liquid crystal display panel displays the white image.

In practice, the backlight driving circuit 20 has a static working state, before the backlight driving circuit 20 receives the image signal of the image corresponding to the first reference brightness value, and a dynamic working state, after the backlight driving circuit 20 receives the image signal of the image corresponding to the first reference brightness value.

Thus, the luminous intensity of the load 24 of the backlight driving circuit 20 is set when the backlight driving circuit 20 is in the static working state. The backlight driving circuit 20 sets the luminous intensity for the load 24 thereof automatically when the backlight driving circuit 20 is in the dynamic working state. The control unit 21 adjusts the output of the first control signal and the second control signal according to the received image signal and thereby adjusts the luminous intensity of the load 24 automatically. Thus, when the backlight driving circuit 20 is in the dynamic working state, the liquid crystal display panel displays the image corresponding to the first reference brightness value, where the brightness of the image is reduced. When the backlight driving circuit 20 is in the dynamic working state, the liquid crystal display panel displays the image corresponding to the second reference brightness value, where the brightness of the image is not reduced.

Accordingly, when the backlight driving circuit 20 is in the dynamic working state, the luminous intensity of the load 24 is adjusted automatically according to the image signal, whereby the display effect of the liquid crystal display is improved, and the liquid crystal display has some satisfied characteristics, such as high contrast and little power consumption.

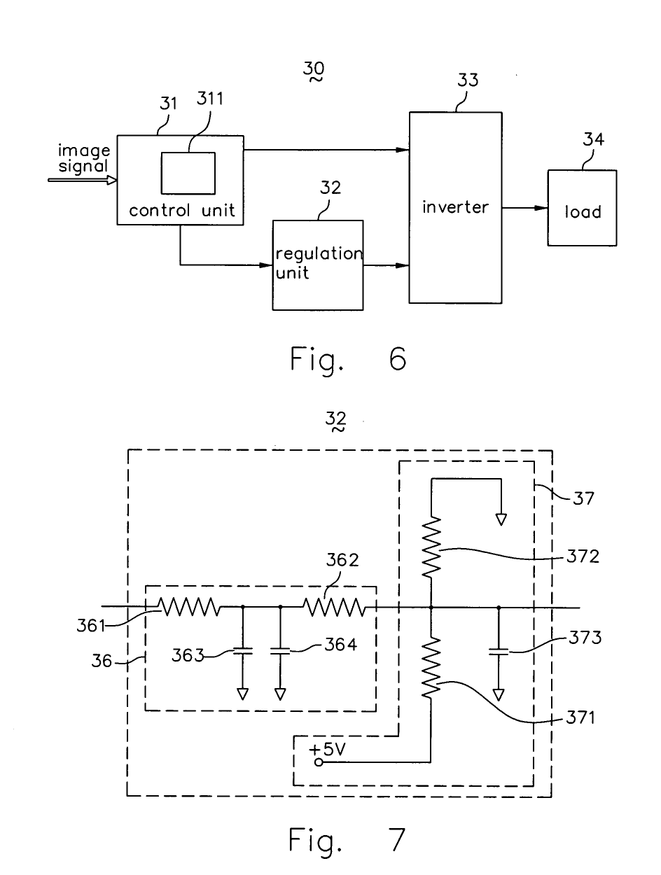

FIG. 6 is a block diagram illustrating a third embodiment of a backlight driving circuit 30 for a liquid crystal display of the present disclosure. In FIG. 6, the liquid crystal display includes a liquid crystal display panel (not shown) and the backlight driving circuit 30. The backlight driving circuit 30 includes a control unit 31, a regulation unit 32, an inverter 33 and a load 34. The control unit 31 includes a reset circuit 311.

The control unit 31 provides a first control signal to the inverter 33 according to an external image signal and a second control signal to the regulation unit 32 according to the external image signal. The regulation unit 32 receives the second control signal and provides a modulation voltage to the inverter 33 according to the second control signal. The inverter 33 receives the first control signal and the modulation voltage and provides a modulation current for adjusting a working current of the load 24 according to the first control signal and the modulation voltage.

The modulation voltage is a direct current voltage. The load 34 provides light for the liquid crystal display panel. The first and the second control signals are pulse signals. Each of the first and the second control signals has a duty ratio, and the amplitude of each of the first and the second control signals may be about 3.3V, in one embodiment. The load 34 is one or more lamps, such as cold cathode fluorescent lamps, for example. The load 34 is disposed on the side edge of the liquid crystal display panel or on the rear face of the liquid crystal display panel.

FIG. 7 is a schematic diagram showing one embodiment of the regulation unit 32 of FIG. 6. The regulation unit 32 includes an integrating circuit 36 and a voltage divider circuit 37. The integrating circuit 36 includes a first resistor 361, a second resistor 362, a first capacitor 363 and a second capacitor 364. The first and the second resistors 361 and 362 are connected in series between the control unit 31 and the inverter 33. The first and the second capacitors 363 and 364 are connected in parallel between the at least one node and ground, where the node is positioned between the first resistor 361 and the second resistor 362. The first resistor 361, the second resistor 362, the first capacitor 363 and the second capacitor 364 physically constitute a RC circuit. The voltage divider circuit 37 includes a third resistor 371, a fourth resistor 372 and a third capacitor 373. The third resistor 371 and the second resistor 372 are connected in series between a direct current voltage source (e.g., 5V) and the ground. A node between the third resistor 371 and the fourth resistor 372 is connected to the inverter 33. Therefore, the direct current voltage source is coupled to the inverter 33 via the third resistor 371 and is coupled to the ground via the third resistor 371 and the third capacitor 373. The integrating circuit 36 may be used to transform the second control signal into direct current voltage, and the voltage divider circuit 37 may be used to divide the direct current voltage to obtain the modulation voltage.

The control unit 31 receives the external image signal and determines the received image signal further while the backlight driving circuit 30 is in normal operation.

The control unit 31 may output the first control signal before receiving the image signal corresponding to a black image, where the duty ratio of the first control signal is set according to a requirement for brightness of the image as requested by a user. The range of the duty ratio of the first control signal is from 0% to 100%. Meanwhile, the control unit 31 may output the second control signal having a first duty ratio.

When receiving the image signal corresponding to a black image, the control unit 31 may output the first control signal with a corresponding duty ratio according to calculation result of the received image signal. The calculation result represents a brightness reference value of the image corresponding to the received image signal. The linear or nonlinear relationship between the calculation result and the duty ratio of the first control signal is predetermined. For example, the calculation result may be from 0 to 100, where “0” represents a darkest image (the image signal corresponding to the black image), and “100” represents a brightest image (the image signal corresponding to a white image); the range of the duty ratio of the first control signal is from 20% to 100%. The control unit 21 may have a determining circuit for determining the received image signal to generate the calculation result. For example, the determining circuit may preload data of the correlation between varied image signals and corresponding brightness values. When receiving the image signal of a designated portion of the image, the determining circuit may determine the received image signals to obtain the average brightness value of the image. Meanwhile, the control unit 31 may output the second control signal having a second duty ratio. The first duty ratio is greater than the second duty ratio. For example, the first duty ratio may be 100%, and the second duty ratio may be 20%. After the control unit 31 receives the image signal corresponding to the black image, the duty ratio of the second control signal is varied between the first duty ratio and the second duty ratio according to the image brightness corresponding to the received image signal. In other words, the control unit 31 outputs the second control signal having the duty ratio corresponding to the image brightness, wherein the duty ratio is between the first duty ratio and the second duty ratio at this time.

Thus, after receiving the image signal corresponding to the black image, the control unit 31 may automatically control the duty ratio of the first control signal and the duty ratio of the second control signal according to the brightness value of the image corresponding to the received image signal.

The reset circuit 311, including controls disposed on the external surface of the liquid crystal display, may reset the first and the second control signals according to requirements, whereby the control unit 31 may output the first and the second control signals as if the control unit 31 never received the image signal corresponding to the black image. Therefore, the user may control the reset circuit 311, whereby the first control signal has the duty ratio set by the user, and furthermore the second control signal has the first duty ratio.

In view of the above, the control unit 31 may output the second control signal having the first duty ratio before receiving the image signal corresponding to the black image. Meanwhile, the regulation unit 32 may output the modulation voltage called a first modulation voltage. The control unit 31 may output the second control signal having the second duty ratio when receiving the image signal corresponding to the black image. Meanwhile, the regulation unit 32 may output the modulation voltage called a second modulation voltage. The first modulation voltage is greater than the second modulation voltage because the first duty ratio is greater than the second duty ratio. For example, when the first and the second duty ratios are 100% and 20% respectively, the first modulation voltage may be about 2.1 V and the second modulation voltage may be about 0.6 V.

The inverter 33 receives the first control signal and the modulation voltage and adjusts the duty ratio of the modulation current and the amplitude of the modulation current respectively according to the first control signal and the modulation voltage, causing the duty ratio of the modulation current and the amplitude of the modulation current to be reduced respectively. The magnitude of the modulation current is in direct proportion to the duty ratio of the first control signal and is also in direct proportion to the magnitude of the modulation voltage. Therefore, the duty ratio of the first control signal is reduced, whereby the duty ratio of the modulation current is reduced. Alternatively, the modulation voltage is reduced, whereby the amplitude of the modulation current is reduced. The modulation current is reduced when the duty ratio of the first control signal and the modulation voltage are reduced simultaneously. Meanwhile, the magnitude of the working current of the load depends on the magnitude of the modulation current. When the modulation current is reduced, the working current of the load 24 is reduced. The correlation among the modulation current, the modulation voltage and the first control signal may be set according to an equation. In one example, the equation may be I=3.14×V×D÷1.414, where “I” represents the modulation current, “V” represents the modulation voltage and “D” represents the duty ratio of the first control signal.

Thus, when the liquid crystal display displays the black image, the backlight intensity of the backlight driving circuit 30 is relatively low. After the black image is displayed, the backlight driving circuit 30 adjusts the duty ratio of the first control signal and the duty ratio of the second control signal according to the image signal and furthermore adjusts the duty ratio of the modulation current and the amplitude of the modulation current, where the modulation current is output by the inverter 33; such that luminous intensity of the load 34 is relatively low when the liquid crystal display displays the black image. Afterward the luminous intensity of the load 34 is adjusted automatically according to the image signal when the liquid crystal display displays the image, where the brightness of the white image is not reduced when the liquid crystal display displays the white image.

In general, when the liquid crystal display displays the white image, the variation range from the maximal brightness to the minimal brightness is narrow by means of only adjusting either the duty ratio of the modulation current or the amplitude of the modulation current but not both. For example, when the liquid crystal display displays the white image, the maximal brightness may be 300 lumen, and the minimal brightness may be 67 lumen, so that the adjustment range of the brightness is (300−67)÷300=75%.

When the liquid crystal display displays the black image, the first control signal is capable of controlling the duty ratio of the modulation current to the minimum of the normal working range of the duty ratio, and the second control signal is capable of controlling the amplitude of the modulation current to the minimum of the normal working range of the amplitude. Therefore, the liquid crystal display may simultaneously adjust the duty ratio of the modulation current and the amplitude of the modulation current. Thus, the magnitude of the modulation current is less than that of the foregoing modulation current of the general liquid crystal display, where the foregoing modulation current is adjusted by means of only adjusting either the duty ratio of the modulation current or the amplitude of the modulation current but not both, whereby the brightness of the black image is relatively low when the liquid crystal display displays the black image. The backlight driving circuit 30 may simultaneously adjust the duty ratio of the modulation current and the amplitude of the modulation current; therefore, the contrast of the liquid crystal display is increased. For example, when the liquid crystal display displays the white image, the maximal brightness of the general liquid crystal display may be 300 lumen; when the general liquid crystal display displays the black image, the maximal brightness of the general liquid crystal display may be about 0.014 lumen, so that the contrast is greater than 20000:1. Therefore, when the liquid crystal display displays the image, the visual effects of the image are desirable. When the liquid crystal display displays the white image, the maximal brightness may be 300 lumen, and the minimal brightness is 12 lumen, so that the adjustment range of the brightness is (300−12)÷300=96%.

After receiving the image signal corresponding to the black image, the backlight driving circuit 30 automatically adjusts the modulation current according to the received image signal corresponding to the image brightness and thereby adjusts the luminous intensity of the load 34. Thus, the display effect of the liquid crystal display is improved, and the liquid crystal display has some satisfied characteristics, such as high contrast and lower power consumption.

The scope of the present application is not intended to be limited to the above embodiments. For instance, in the first embodiment, when receiving the image signal corresponding to the black image, the control unit 11 outputs the first control signal, wherein the duty ratio of the first control signal that is maintained corresponds to the brightness set by the user, and the duty ratio of the second control signal is changed to the second duty ratio.

Furthermore, in the first embodiment, the second control signal may be a direct current voltage signal. The magnitude of the second control signal is a first voltage before the control unit 11 receives the image signal corresponding to the black image; the magnitude of the second control signal is a second voltage after the control unit 11 receives the image signal corresponding to the black image, wherein the first voltage is greater than the second voltage. The first voltage may be about 2.1V, and the second voltage may be about 0.6V.

Furthermore, in the third embodiment, the regulation unit 32 may be omitted. When the backlight driving circuit 30 is in the static working state, the control unit 31 outputs the second control signal that is a direct current voltage being about 2.1V to the inverter 33. When the backlight driving circuit 30 is in the dynamic working state, the control unit 31 outputs the second control signal that is a direct current voltage being about 0.6V to the inverter 33. The above working process is accomplished by hardware or software in the control unit 31.

Furthermore, in the third embodiment, the reset circuit 311 may be integrated with an OSD unit. The user adjusts content of the OSD unit to reset the first control signal and the second control signal.

Furthermore, in the third embodiment, the reset circuit 311 may be disposed outside the control unit 31 and reset the first control signal and the second control signal through the control unit 31.

Furthermore, in the third embodiment, the control unit 31 may change the start-up conditions of a dynamic working mode of the backlight driving circuit 30; accordingly, the backlight driving circuit 30 is set into the dynamic working mode on condition that the backlight driving circuit 30 receives the image signal corresponding to a specific brightness value of the image.

Furthermore, in the second embodiment, when the backlight driving circuit 20 is in the dynamic working state, the control unit 21 may automatically adjust the second control signal according to the image brightness value corresponding to the received image signal and output the second control signal, and the modulation voltage that is changed depends on the second control signal; for, example, when the image brightness value corresponding to the image signal that is received by the control unit 21 is varied, the duty ratio of the second control signal is changed between the first duty ratio and the second duty ratio according as the image brightness value is varied. The change of the duty ratio of the second control signal is accomplished by hardware or software in the control unit 21; the change may be linear variation or nonlinear variation, and furthermore the change may be continuous variation or discontinuous variation.

Furthermore, in the second embodiment, the control unit 21 may output the second control signal; the duty ratio of the second control signal is constant during the static working state and the dynamic working state. The second control signal has a first frequency during the static working state; the second control signal has a second frequency during the dynamic working state, wherein the first frequency is greater than the second frequency. The first frequency corresponds to the first modulation voltage, and the second frequency corresponds to the second modulation voltage.

Furthermore, in the second embodiment, the control unit 21 may output a plurality of first control signals and a plurality of second control signals; the first control signals are capable of adjusting the duty ratio of the modulation current, and the second control signals are capable of adjusting the amplitude of the modulation current.

Furthermore, in the second embodiment, the control unit 21 may output at least one control signal. When the static working state is changed to the dynamic working state, the duty ratio of the at least one control signal and the frequency of the at least one control signal are reduced respectively, and thereby the duty ratio of the modulation current and the frequency of the modulation current are reduced respectively.

Furthermore, in the second embodiment, the control unit 21 may output at least one control signal. When the static working state is changed to the dynamic working state, the duty ratio of the at least one control signal and the amplitude of the at least one control signal are reduced respectively, and thereby the duty ratio of the modulation current and the amplitude of the modulation current are reduced respectively.

Furthermore, in the second embodiment, the control unit 21 may output a third control signal to the inverter 23. The frequency of the third control signal in the static working state is greater than the frequency of the third control signal in the dynamic working state, and thereby the frequency of the modulation current in the static working state is greater than the frequency of the modulation current in the dynamic working state.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the disclosure to the full extent indicated by the broad general meaning of the terms in which the appended claims are expressed.

What is claimed is:

1. A liquid crystal display, comprising:
a backlight driving circuit comprising a control unit; and
an inverter connected to the control unit and a load connected to the inverter;
wherein the control unit provides a first control signal and a second control signal to the inverter according to a degree of brightness of an external image signal, and wherein the inverter adjusts luminous intensity of the load according to the first control signal and the second control signal.

2. The liquid crystal display of claim 1, wherein the inverter outputs a modulation current according to the first and the second control signals, the first control signal for adjusting a duty ratio of the modulation current and the second control signal for adjusting an amplitude of the modulation current.

3. The liquid crystal display of claim 2, wherein the first control signal and the second control signal are pulse signals.

4. The liquid crystal display of claim 3, wherein the control unit receives the external image signal to determine a brightness value of an image corresponding to the external image signal to generate a calculation result, and a working state of the backlight driving circuit is changed from a static working state to a dynamic working state when the calculation result satisfies a first reference brightness value that is predetermined.

5. The liquid crystal display of claim 4, wherein when the backlight driving circuit is in the static working state, a duty ratio of the first control signal is set by a user, and the second control signal has a predetermined first duty ratio; when the backlight driving circuit is in the dynamic working state, the duty ratio of the first control signal is provided by the control unit according to the brightness value of the image corresponding to the external image signal, and the second control signal has a second duty ratio, wherein the first duty ratio is greater than the second duty ratio.

6. The liquid crystal display of claim 5, wherein a duty ratio of the first control signal is determined according to a brightness requirement of the image of the user when the backlight driving circuit is in the static working state, and the duty ratio of the first control signal is changed between about 20% and about 100% when the backlight driving circuit is in the dynamic working state.

7. The liquid crystal display of claim 4, wherein the first reference brightness value corresponds to a black image.

8. The liquid crystal display of claim 4, wherein when the backlight driving circuit is in the dynamic working state and the control unit receives a second reference value that is predetermined, a duty ratio of the second control signal is changed from the second duty ratio to the first duty ratio.

9. The liquid crystal display of claim 8, wherein the second reference value corresponds to a white image.

10. The liquid crystal display of claim 1, wherein the first control signal is a pulse signal, and the second control signal is a direct current voltage signal.

11. The liquid crystal display of claim 10, wherein magnitude of the second control signal is a first voltage before the control unit receives the image signal corresponding to a black image, and magnitude of the second control signal is a second voltage after the control unit receives the image signal corresponding to the black image, wherein the first voltage is greater than the second voltage.

12. A liquid crystal display, comprising:
a control unit; and
an inverter;
a regulation unit and a load;
wherein the control unit provides a first control signal to the inverter according to a degree of brightness of an external image signal, and provides a second control signal to the regulation unit according to the degree of the brightness of the external image signal;
wherein the regulation unit provides a modulation voltage to the inverter according to the second control signal, and wherein the inverter outputs a modulation current to the load, the modulation current capable of adjusting luminous intensity of the load.

13. The liquid crystal display of claim 12, wherein the regulation unit comprises an integrating circuit to transform the second control signal into direct current voltage, the integrating circuit comprising a first resistor and a second resistor connected in series between the control unit and the inverter, the integrating circuit further comprising a capacitive circuit connected between a common node of the first resistor and the second resistor and ground.

14. The liquid crystal display of claim 13, wherein the regulation unit further comprises a voltage divider circuit to transform the direct-current voltage transformed by the integrating circuit into the modulation voltage.

15. The liquid crystal display of claim 12, wherein the control unit receives the external image signal to determine a brightness value of an image corresponding to the external image signal to generate a calculation result, wherein when the calculation result does not satisfies a predetermined reference brightness value, a duty ratio of the first control signal is set by a user, and the second control signal has a predetermined first duty ratio, and wherein when the brightness value satisfies the predetermined reference brightness value, the duty ratio of the first control signal is provided by the control unit according to an average brightness value of the image, and the second control signal has a predetermined second duty ratio, wherein the first duty ratio is greater than the second duty ratio.

16. The liquid crystal display of claim 15, wherein the control unit adjusts the duty ratio of the second control signal according to the brightness of the image corresponding to the external image signal after the brightness of the image corresponding to the external image signal that is received by the control unit is the predetermined reference brightness value, wherein the duty ratio of the second control signal is changed between the first duty ratio and the second duty ratio according as the brightness of the image is varied.

17. A liquid crystal display, comprising:
a control unit;
an inverter and a load;
wherein the control unit receives an external image signal and provides at least one control signal to the inverter according to a degree of brightness of the external image signal, and wherein the inverter adjusts a working current of the load according to the control signal.

18. The liquid crystal display of claim 17, wherein the at least one control signal has different duty ratios and frequencies corresponding to the different external image signals.

19. The liquid crystal display of claim 17, wherein the at least one control signal has different duty ratios and amplitudes corresponding to the different external image signals.
